(19) United States
(12) Patent Application Publication
(10) Pub. No.: US 2026/0174609 A1
(43) Pub. Date: Jun. 25, 2026

(54) MOBILE MANUAL STANDING WHEELCHAIR

(71) Applicants: Regents of the University of Minnesota, Minneapolis, MN (US); THE UNITED STATES GOVERNMENT, AS REPRESENTED BY THE DEPARTMENT OF VETERANS AFFAIRS, Washington, DC (US)

(72) Inventors: Andrew Hansen, Minneapolis, MN (US); Jonathon Gallaher, Minneapolis, MN (US); Gregory Voss, Minneapolis, MN (US); Eric Nickel, Minneapolis, MN (US); Gary Goldish, Minneapolis, MN (US)

(21) Appl. No.: 19/123,152

(22) PCT Filed: Oct. 27, 2023
(86) PCT No.: PCT/US2023/078026

§ 371 Date: Apr. 22, 2025

Related U.S. Application Data
(60) Provisional application No. 63/420,251, filed on Oct. 28, 2022.

(51) Int. Cl. A61G 5/14; A61G 5/02; A61G 5/10; A61G 5/12

(52) U.S. Cl. CPC A61G 5/14; A61G 5/02; A61G 5/1054; A61G 5/122; A61G 5/128

(57) ABSTRACT

A standing wheelchair includes a chassis, a pair of rear drive wheels and a pair of front support wheels. The chassis includes a sitting mode, in which a support section of the chassis forms a seat configured to support a user in a sitting position, and a standing mode, in which the support section is configured to support a user in a standing position. The pair of rear drive wheels is connected to the chassis on a rear side of the support section. The pair of front support wheels is connected to the chassis on a front side of the support section, which is opposite the rear side. The rear wheels move closer to the front wheels when the chassis transitions from the sitting mode to the standing mode.

### CROSS-REFERENCE TO RELATED APPLICATION

The present application is based on and claims the benefit of U.S. provisional patent application Ser. No. 63/420,251, filed Oct. 28, 2022, the content of which is hereby incorporated by reference in its entirety.

### FIELD

Embodiments of the present disclosure relate to a rear-wheel drive standing wheelchair that is mobile in both its sitting and standing modes of operation.

### BACKGROUND

Standing wheelchairs generally have a sitting mode, in which a user is supported in a sitting position, and a standing mode, in which a user is supported in a standing position. Standing wheelchairs may also be propelled using drive wheels that are manually operated while in either the sitting mode or the standing mode.

It is important for standing wheelchairs to be stable while in the standing mode, particularly during movement of the standing wheelchair. Thus, quick turning systems, such as systems that utilize drive wheels that are located in the front of the standing wheelchair or in front of the center of gravity and directional support wheels located in the rear of the standing wheelchair, may not be suitable for a standing wheelchair that is to be moveable while in the standing mode due to their unstable nature.

Another factor that is important to the stability of standing wheelchairs, particularly during movement in the standing mode, is the traction of the drive wheels with the ground surface. A loss of traction by one of the drive wheels, such as while moving up an incline, may cause the standing wheelchair to turn abruptly and become unstable. Thus, it is important that the standing wheelchair is configured such that the drive wheels support enough weight while in the standing mode to establish sufficient friction with the ground surface during normal use.

### SUMMARY

Embodiments of the present disclosure relate to a rear-wheel drive standing wheelchair that is mobile in both its sitting and standing modes of operation. One example of the standing wheelchair includes a chassis, a pair of rear drive wheels and a pair of front drive wheels. The chassis includes a sitting mode, in which a support section of the chassis forms a seat configured to support a user in a sitting position, and a standing mode, in which the support section is configured to support a user in a standing position. The pair of rear drive wheels is connected to the chassis on a rear side of the support section. The pair of front support wheels is connected to the chassis on a front side of the support section, which is opposite the rear side. The rear wheels move closer to the front wheels when the chassis transitions from the sitting mode to the standing mode.

According to one embodiment, the front support wheels and the rear drive wheels support the chassis on a floor surface when in the sitting and standing modes.

According to another embodiment, a center of gravity of the standing wheelchair when the chassis, in the sitting mode, supports a user in the sitting position has a first horizontal position that is between an axis of rotation of the rear drive wheels and an axis of rotation of the front support wheels.

According to another embodiment, the center of gravity of the standing wheelchair when the chassis, in the standing mode, supports a user in the standing position has a second horizontal position that is closer to the axis of rotation of the rear drive wheels and the axis of rotation of the front support wheels than when the chassis is in the sitting mode.

According to another embodiment, the support section of the chassis includes a middle frame section and an upper frame section. When the chassis is in the sitting mode, the middle frame section forms a seat platform of the seat and is oriented in a horizontal direction, and the upper frame section forms a backrest of the seat and is oriented in a vertical direction. When the chassis is in the standing mode, the middle frame section and the upper frame section are oriented in the vertical direction and are configured to support a user's torso in a standing orientation.

According to another embodiment, the front support wheels are pivotably connected to a lower frame section of the chassis that includes a footrest. The footrest is configured to support a user's feet when the chassis is in the sitting and standing modes.

According to another embodiment, the middle frame section and the upper frame section are pivotably connected to each other through a pair of first pivotable connections, and the middle frame section is pivotably connected to the lower frame section through a pair of second pivotable connections.

According to another embodiment, a location of the second pivotable connections is adjustable relative to the footrest.

According to another embodiment, a location of the first pivotable connections is adjustable relative to the middle frame section.

According to another embodiment, the chassis includes a pair of side frame members, each side frame member having a first end pivotably connected to the middle frame section and a second end connected to one of the rear drive wheels. The side frame members pivot relative to the middle frame section as the chassis moves between the sitting and standing modes. The second ends of the side frame members move closer to the front support wheels with the rear drive wheels as the chassis moves from the sitting mode to the standing mode.

According to another embodiment, the standing wheelchair includes a pair of manual propulsion wheels, each manual propulsion wheel is connected to the first end of one of the side frame members and is configured to drive rotation of a corresponding one of the rear drive wheels through a drive mechanism.

According to another embodiment, the drive mechanism includes a pair of first gears each connected to one of the manual propulsion wheels, a pair of second gears each connected to one of the rear drive wheels, and a pair of drive loops each connecting one of the first gears to a corresponding one of the second gears. Rotation of each manual propulsion wheel drives rotation of the corresponding first gear, which drives movement of the drive loop, rotation of the corresponding second gear, and rotation of the rear drive wheel.

According to another embodiment, each drive loop includes a chain or a belt.

According to another embodiment, rotation of each manual propulsion wheel drives rotation of the corresponding rear drive wheel when the chassis is in both the sitting mode and the standing mode.

According to another embodiment, the first gears are each configured to rotate about an axis about which the first end of the corresponding side frame member pivots relative to the middle frame section.

According to another embodiment, each of the first gears is configured to rotate about a gear axis, and the first end of the corresponding side frame member is configured to pivot relative to the middle frame section about an axis that is different from the first gear axis.

According to another embodiment, the standing wheelchair includes an axle extending through hubs of the rear drive wheels and through the second gears.

According to another embodiment, the standing wheelchair includes one or more actuators. Each actuator is configured to assist in driving the chassis from the sitting mode to the standing mode and includes a first end that is connected to the side frame members and a second end that is connected to the support section.

According to another embodiment, the one or more actuators include a gas spring actuator.

According to another embodiment, the one or more actuators include a motorized actuator.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of an example of a standing wheelchair in accordance with embodiments of the present disclosure.

FIGS. 2 and 3 are simplified side views of an example of a standing wheelchair respectively in a sitting mode and a standing mode, in accordance with embodiments of the present disclosure.

FIGS. 4 and 5 are front isometric views of an example of a standing wheelchair respectively in a sitting mode and a standing mode, in accordance with embodiments of the present disclosure.

FIG. 6 is a simplified diagram of an example of electronics of the standing wheelchair, in accordance with embodiments of the present disclosure.

FIG. 7 is a rear isometric view of the standing wheelchair of FIG. 4 in the sitting mode, in accordance with embodiments of the present disclosure, with some of the components removed.

FIG. 8 is a left side view of the standing wheelchair of FIG. 4 in the sitting mode, in accordance with embodiments of the present disclosure, with some of the left side components removed.

FIG. 9 is a side view of the standing wheelchair of FIG. 8 in an intermediary position between the sitting mode and the standing mode, in accordance with embodiments of the present disclosure.

FIG. 10 is a side view of the standing wheelchair of FIG. 8 in the standing mode, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

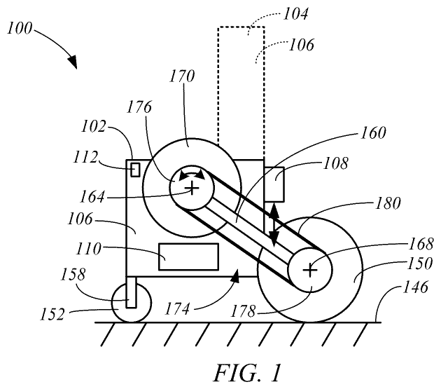

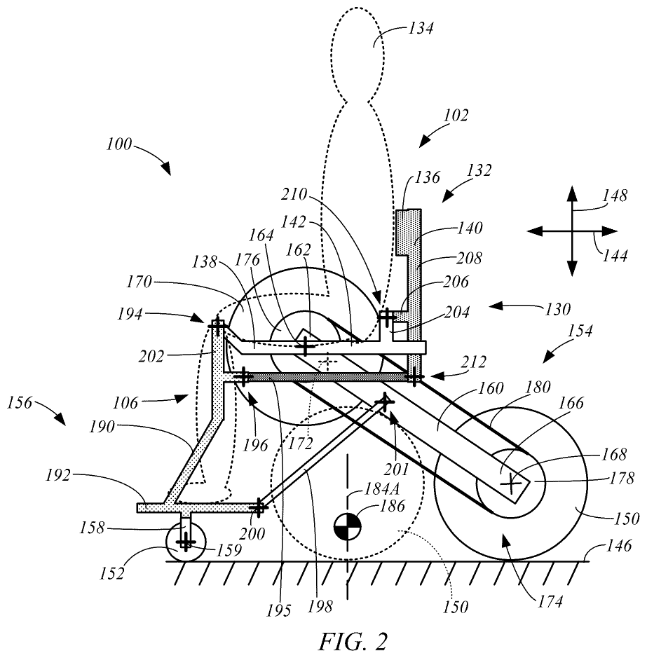

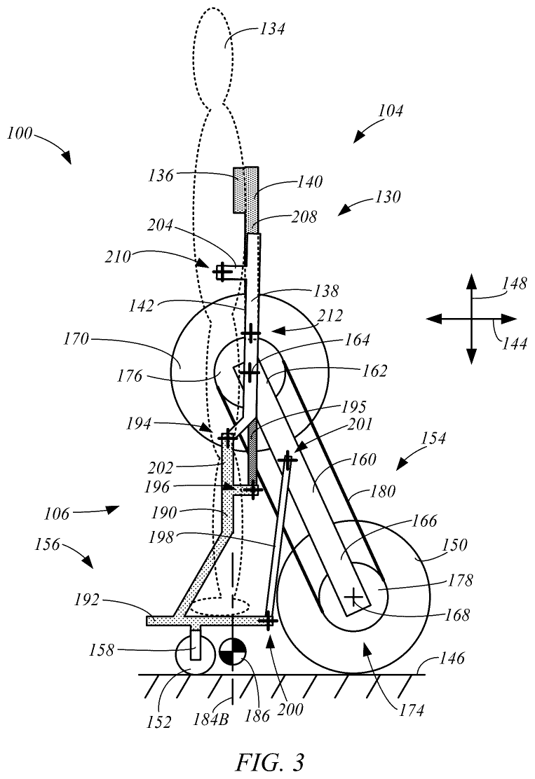

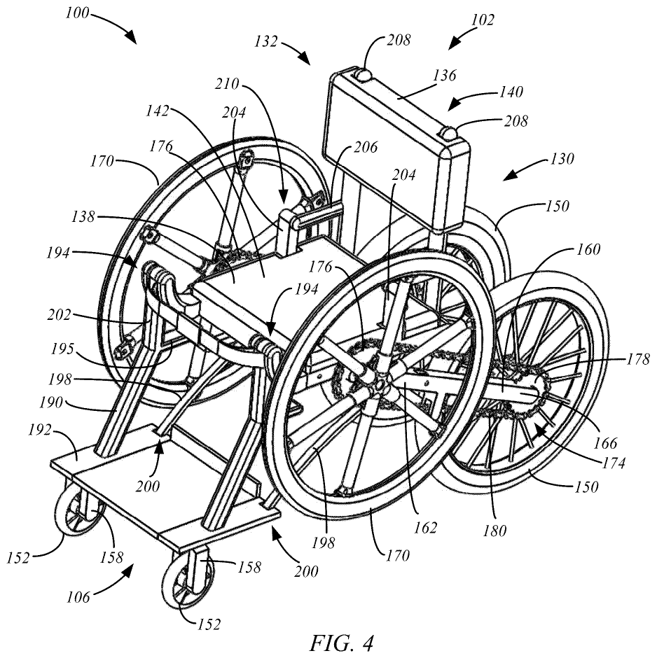

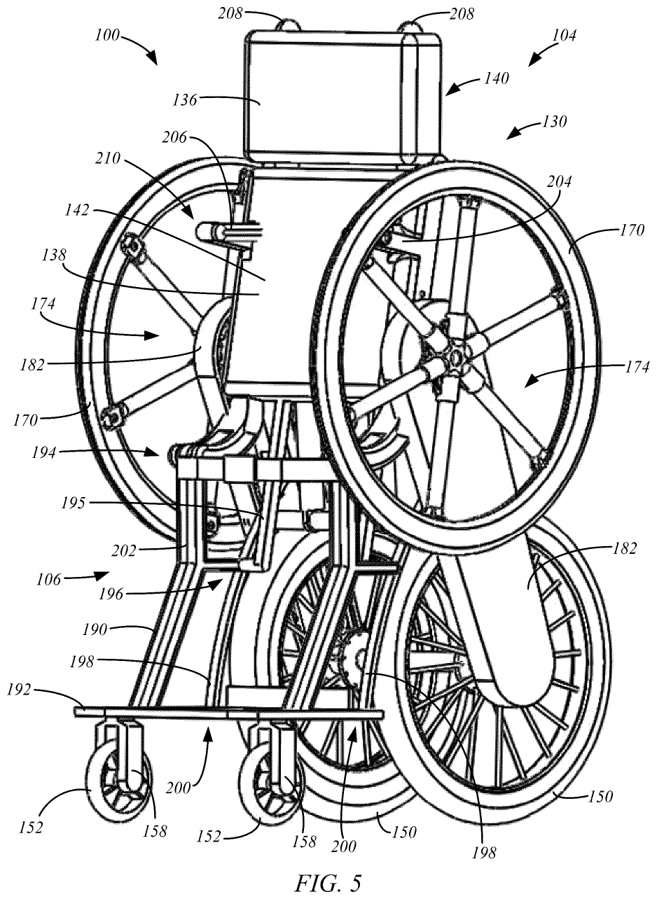

Embodiments of the present disclosure are directed to a mobile standing wheelchair 100, examples of which are shown in FIGS. 1-5, in accordance with various embodiments of the present disclosure. FIG. 1 is a highly simplified diagram of the standing wheelchair 100, FIGS. 2 and 3 are simplified side views of the standing wheelchair 100 respectively in a sitting mode 102 and a standing mode 104, and FIGS. 4 and 5 are isometric views of the standing wheelchair 100 respectively in the sitting mode 102 and the standing mode 104. Some of the near-side components of the wheelchair 100 are not shown in FIGS. 2 and 3 to more clearly illustrate certain features. In some embodiments, the wheelchair 100 is specifically sized for children. However, the wheelchair 100 may also be sized for adults.

The wheelchair 100 includes a chassis 106 that facilitates the sitting mode 102 (solid box in FIG. 1) and the standing mode 104 (dashed box in FIG. 1). In some embodiments, the wheelchair 100 includes a motorized actuator 108, electronics 110, and a control panel 112 that are supported by the chassis 106, as shown in FIG. 1.

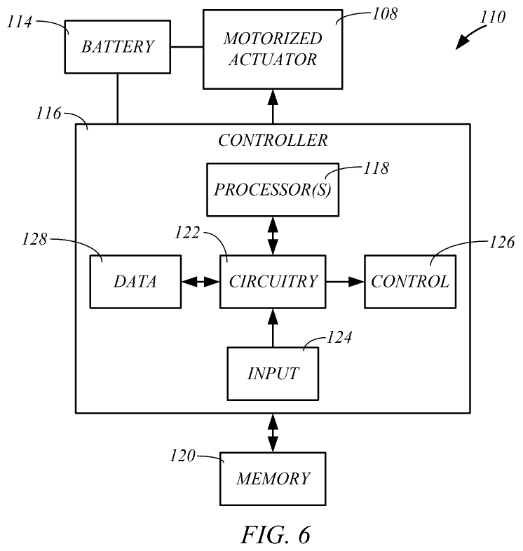

FIG. 6 is a simplified diagram of an example of the electronics 110, in accordance with embodiments of the present disclosure. The electronics 110 may include a battery 114 and a controller 116. The controller 116 is generally configured to perform one or more functions described herein, such as the control of the motorized actuator 108 through power supplied by the battery 114, or other electrical components of the wheelchair 100. The controller 116 may take on any suitable form.

In one example, the controller 116 includes one or more processors 118 that control the motorized actuator to transition the wheelchair 100 between the sitting and standing modes and possibly other functions in response to the execution of instructions stored in memory 120. The processors 118 of the controller 116 may be components of computer-based systems, and may include control circuits, microprocessor-based engine control systems, and/or programmable hardware components, such as a field programmable gate array (FPGA). The memory 120 represents local and/or remote memory or computer readable media. Such memory comprises any suitable patent subject matter eligible computer readable media that do not include transitory waves or signals. Examples of suitable forms of the memory 120 include hard disks, CD-ROMs, optical storage devices, and/or magnetic storage devices. The controller 116 may include circuitry 122 for use by the one or more processors 118 to receive input signals 124, issue control signals 126, and or communicate data 128, such as in response to the execution of the instructions stored in the memory 120.

The control panel 112 (FIG. 1) of the wheelchair 100 may include buttons or other suitable input devices that generate input signals for controlling the motorized actuator 108. For example, the control panel 112 may allow the user to generate an input signal 124 to the controller 116 to transition the wheelchair 100 from the sitting mode 102 to the standing mode 104, and from the standing mode 104 back to the sitting mode 102. The control panel 112 may also allow the user to perform other functions relating to the operation of the motorized actuator 108 or other components of the wheelchair 100.

In some embodiments, the chassis 106 includes a support section 130 that forms a seat 132 that is configured to support a user 134 in a sitting position when the wheelchair 100 or chassis 106 is in the sitting mode 102, as indicated in FIG. 2. The support section 130 is also configured to form a backrest 136 that aids in supporting the back of the user 134 when the wheelchair 100 or chassis 106 is in the standing mode 104, as indicated in FIG. 3.

In one example, the support section 130 includes a middle frame section 138 and an upper frame section 140. When the chassis 106 is in the sitting mode 102, the middle frame section 138 includes a seat platform 142 of the seat 132 and is oriented in a horizontal direction along a horizontal axis 144, which is generally parallel to a floor surface 146, as shown in FIG. 2. This means that the plane of the seat platform 142 is approximately (e.g., +/−20 degrees) parallel to the horizontal axis 144 and is approximately (+/−20 degrees) perpendicular or substantially transverse to a vertical axis 148, which is perpendicular to the horizontal axis 144.

In one embodiment, the upper frame section 140 includes the backrest 136 of the seat 132 and is oriented in a vertical direction when the wheelchair 100 is in the sitting mode 102. This means that the plane of the backrest is approximately (e.g., +/−20 degrees) parallel to the vertical axis 148 and is approximately (+/−20 degrees) perpendicular or substantially transverse to the horizontal axis 144.

In some embodiments, when the chassis 106 is in the standing mode 104, the middle frame section 138 and the upper frame section 140 are both oriented in the vertical direction and are configured to support the torso of the user 134 in a standing orientation, as indicated in FIG. 3.

The wheelchair 100 includes a pair of rear drive wheels 150 and a pair of front directional support wheels 152, all of which are connected to the chassis 106, and support the chassis 106 on the ground surface 146. The rear drive wheels 150 are located on a rear side 154 of the support section 130 and the front wheels 152 are located on a front side 156 of the support section 130. In one embodiment, the wheels 150 and 152 are all in contact with a flat ground surface 146 while the wheelchair 100 is in both the sitting mode 102 and the standing mode 104, as indicated in FIGS. 2 and 3.

The rear drive wheels 150 operate to propel the wheelchair 100 along the surface 146 and are driven either manually by the user or using an electric motor. The front directional support wheels 152 are attached to the chassis 106 through a suitable pivotable support 158. The front wheels 152 are each configured to rotate about an axis 159 as the wheelchair 100 travels across the ground surface 146. The pivotable supports 158 allow the wheels 152 to swivel about a vertical axis and facilitate turning the wheelchair 100.

In some embodiments, the chassis 106 includes a pair of side frame members 160. An end 162 of each side frame member 160 is pivotably connected to the middle frame section 138 and is configured to rotate or pivot about an axis 164. Each of the rear wheels 150 may be attached or supported by an end 166 of the corresponding side frame member 160 and is configured to rotate about an axis 168 having a fixed position and orientation relative to the side frame member 160. The side frame members 160 each pivot about the corresponding axis 164 in a clockwise direction when viewed from the left side (FIGS. 2 and 3), to transition the wheelchair 100 between the sitting mode 102 and the standing mode 104.

In some embodiments, the wheelchair 100 is configured to be manually propelled by the user's hands and arms using a pair of propulsion wheels 170. The propulsion wheels 170 are positioned for easy access by the hands of the user while the wheelchair 100 is in both the sitting mode 102 and the standing mode 104, thus allowing the user to independently drive the rotation of each rear drive wheel 150 and manually move the wheelchair 100 while in both the sitting mode 102 and the standing mode 104.

In one embodiment, each of the propulsion wheels 170 is supported by one of the side frame members 160 for rotation about an axis, which may be coaxial to the axis 164 about which the corresponding side frame member 160 rotates, as indicated in FIGS. 2 and 3. However, it is understood that embodiments of the present disclosure include configuring the propulsion wheels 170 to rotate about an axis 172 (phantom lines) that is different from the axis 164, as indicated in FIG. 2. The attachment of propulsion wheels 170 to the side frame members 160 fixes the relative positions of the axes of rotation of the propulsion wheels 170 to the axis of rotation 168 of the corresponding rear drive wheel 150.

Each propulsion wheel 170 may be configured to drive the rotation of the corresponding rear drive wheel 150 through a drive mechanism 174. The drive mechanism 174 may take on any suitable form. In one example, the drive mechanism 174 comprises a pair of gears 176 and a pair of gears 178. Each of the gears 176 is connected to one of the propulsion wheels 170 and is configured to rotate (e.g., about the axis 164) with rotation of the corresponding propulsion wheel 170. Each of the gears 178 is configured to rotate about the axis of rotation 168 of the corresponding rear drive wheel 150. A drive loop 180 connects each pair of gears 176 and 178 such that rotation of the propulsion wheel 170 drives rotation of the gear 176, which drives rotation of the drive loop 180, which drives rotation of the gear 178 and the rear drive wheel 150. Examples of the drive loop 180 include a chain (FIG. 4), a belt, or another suitable component. In some embodiments, a cover 182 may be placed over the gears 176 and 178 and the drive loop 180, as indicated in FIG. 5.

The relative positions of the front wheels 152 and the rear wheels 150 change during transitions between the sitting mode 102 and standing mode 104. In some embodiments, the rear wheels 150 are positioned farther from the front wheels 152 along the horizontal axis 144, which is generally parallel to the flat surface 146, when the chassis 106 is in the sitting mode 102 than when the chassis 106 is in the standing mode 104. This is generally illustrated in FIG. 2, in which the position of the rear wheel 150 along the axis 144 relative to the front wheel 152 is shown in phantom lines. Thus, during a transition of the chassis 106 from the sitting mode 102 to the standing mode 104, the rear wheels 150 move along the horizontal axis 144 toward the front wheels 152, and during a transition of the chassis 106 from the standing mode 104 to the sitting mode 102, the rear wheels 150 move along the horizontal axis 144 away from the front wheels 152. The chassis 106 may facilitate this relative movement of the front wheels 152 and the rear wheels 150 using numerous techniques, examples of which will be described in greater detail below.

It is important for the wheelchair 100 to be stable during movement, particularly when the wheelchair 100 is in the standing position 104. While the wheelchair 100 is in the sitting mode 102 and is supporting a sitting user 134 (FIG. 2), a horizontal position 184A of the center of gravity 186 of the wheelchair 100 along the horizontal axis 144 is located between the front wheels 152 and the rear wheels 150, as indicated in FIG. 2. Likewise, the horizontal position 184B of the center of gravity 186 of the wheelchair 100 is also located between the front wheels 152 and the rear wheels 150 when the wheelchair 100 is in the standing mode 104 and supports a standing user 134, as indicated in FIG. 3. The horizontal position 184B is closer to the axis of rotation 159 of the front wheels 152 and the axis of rotation 168 of the rear wheels 150 than the horizontal position 184A. The centralized horizontal positions 184 of the center of gravity 186 aid in stabilizing the wheelchair 100 in the sitting mode 102 and the standing mode 104 and reduce the likelihood of tipping during movement of the wheelchair 100. Additionally, the horizontal position 184 of the center of gravity 186 allows for sufficient loading of the rear drive wheels 150 while the wheelchair 100 is in the standing position 104, which reduces the potential for slippage of the rear wheels 150 during movement.

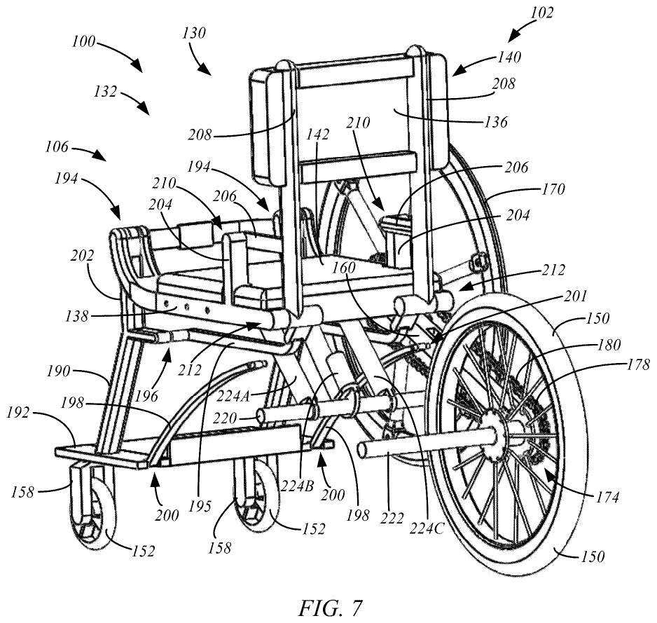

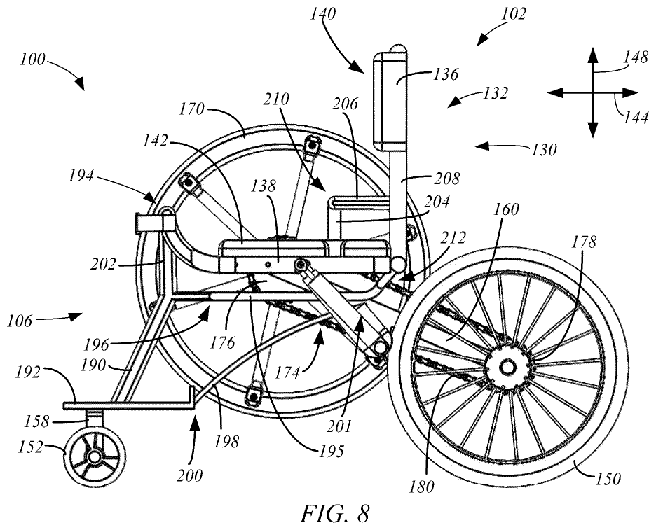

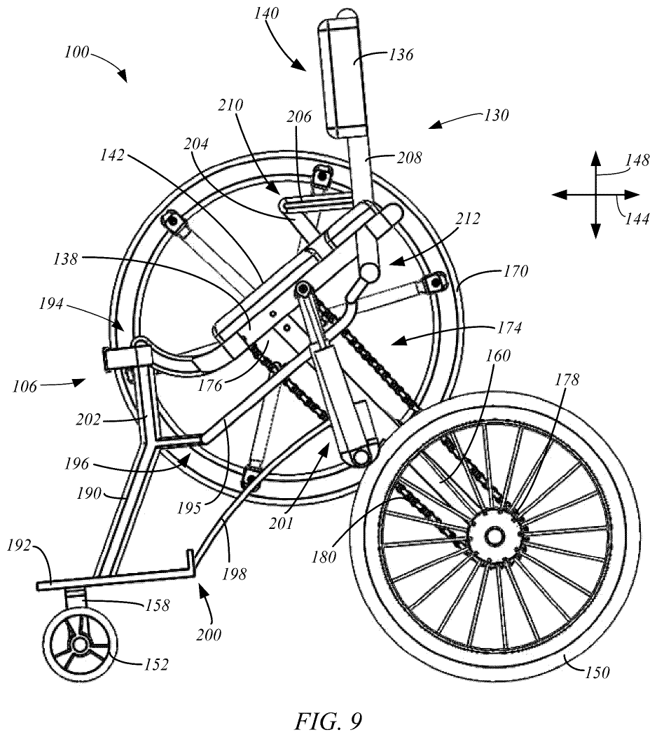

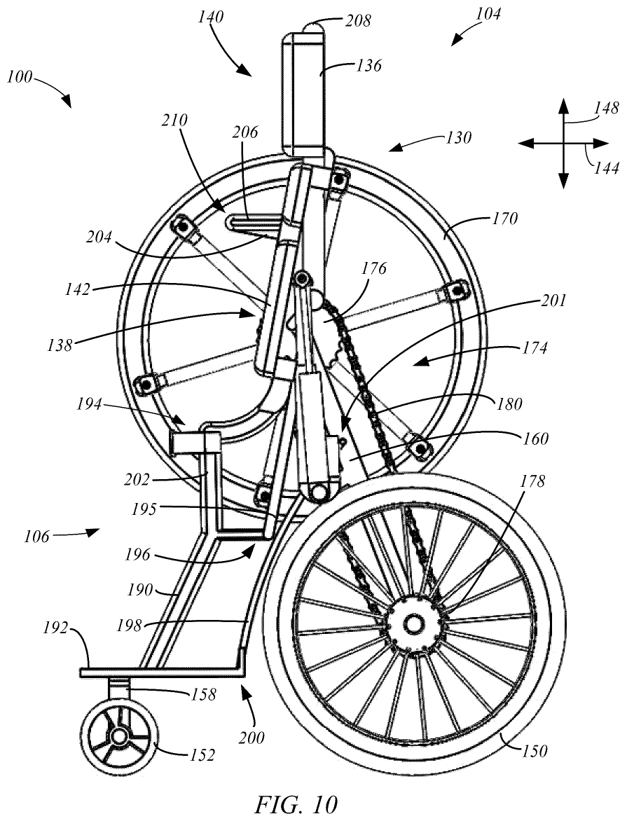

Additional details and embodiments of the wheelchair 100 will be described with reference to FIGS. 2-5 and FIGS. 7-10. FIG. 7 is a rear isometric view of the wheelchair 100 of FIG. 4 in the sitting mode 102 with some of the components (e.g., left rear wheel 150, left frame member 160) removed, FIG. 8 is a left side view of the wheelchair 100 of FIG. 4 in the sitting mode 102 with some of the left side components removed, FIG. 9 is a side view of the wheelchair 100 of FIG. 8 in an intermediary position between the sitting mode 102 and the standing mode 104, and FIG. 10 is a side view of the wheelchair 100 of FIG. 8 in the standing mode 104, in accordance with embodiments of the present disclosure.

The chassis 106 may take on any suitable form while providing one or more of the features described above. In one example, the chassis 106 includes a lower frame section 190. The lower frame section 190 may include a footrest 192 for the feet of the user 134 (FIGS. 2 and 3). The pivotable supports 158 of the front wheels 152 may be connected to the lower frame section 190, such as below the footrest 192, which fixes the relative positions of the pivotable supports 158 and the front wheels 152.

The lower frame section 190 may be pivotably connected to the middle frame section 138 at joints 194, and pivotably connected to a pair of linking arms 195 at joints 196. The lower frame section 190 may also be linked to the side frame members 160 through stabilizing arms 198 at suitable pivotable connections 200 and 201. The stabilizing arms 198 allow the lower frame section 190 to maintain its orientation relative to the ground surface 146, as the chassis 106 moves between the sitting and standing modes, as generally shown in FIGS. 8-10.

The pivotable connections 194 between the lower frame section 190 and the middle frame section 138 are preferably located at the knees of the user to reduce the likelihood of sliding motion between the seat platform 142 and the user's legs when the wheelchair 100 is transitioned between the sitting mode 102 and the standing mode 104. In one embodiment, segments 202 of the lower frame section 190 support the pivotable connections 194 and have an adjustable length (e.g., telescoping segments) that allow for the location of the pivotable connections 194 to be adjusted relative to the footrest 192 and customized to the user.

The middle frame section 138 may include segments 204 that extend from opposing sides of the seat platform 142 and have a fixed relation to the seat platform 142. The upper frame section 140 may include segments 206 that extend from members 208 that support the backrest 136 and have a fixed relation to the members 208. The corresponding pairs of segments 204 and 206 are pivotably connected to each other at joints 210. The members 208 of the upper frame section 140 are pivotably connected to the linking arms 195 at joints 212.

The pivotable connections between the upper frame section 140 and the middle frame section 138 (joints 210), the middle frame section 138 and the lower frame section 190 (joints 194), the lower frame section 190 and the linking arms 195 (joints 196), and the linking arms 195 and the upper frame section 140 (joints 212) result in the formation of a 4-bar linkage. This 4-bar linkage facilitates the transition of the support section 130 from forming the seat 132 when in the sitting mode 102 to forming the torso support when in the standing mode 104.

In some embodiments, the pivotable connections or joints 210 between the middle frame section 138 and the upper frame section 140 are positioned at the approximate location of the hip joint of the user to reduce sliding motion between the user's back, butt and thighs and the upper frame section 140 (e.g., the backrest 136) and the seat platform 142 during transitions of the wheelchair 100 between the sitting mode 102 and the standing mode 104. In one embodiment, the members 208 of the upper frame section 140 have an adjustable length (e.g., telescoping segments) that allows for the location of the pivotable connections 210 to be adjusted, such as relative to the middle frame section 138 or the upper frame section 140, and customized to the user.

The side frame members 160 may be joined together by bar 220 and/or an axel 222, which may support the rear drive wheels 150 and the gears 178. These components ensure that the side frame members 160 pivot together about their axes 164 as the chassis 106 moves from the sitting position (FIG. 8), through an intermediary position (FIG. 9) and to the standing position 104 (FIG. 10). During this transition from the sitting position 102 to the standing position 104, the rear wheels 150 move closer to the front wheels 152 and the lower frame section 190.

The wheelchair 100 may be driven between the sitting and standing modes with the aid of one or more actuators 224 (FIG. 7), such as actuators 224A-C. In one example, each actuator 224 has an end that is connected to the support section 130, such as the middle frame section, and an opposing end that is connected to the side frame members 160, such as to the bar 220 connecting the side frame members 160 together. The actuators 224 may each take the form of a linear actuator having a compact state corresponding to the sitting mode 102. The actuators 224 may be driven to an extended state, which drives the bar 220 and the upper frame section 130 away from each other, to transition the wheelchair 100 to the standing mode 104. The actuators 224 may comprise one or more gas spring actuators, a motorized actuator (e.g., actuator 108 in FIG. 1), or another suitable actuator.

In one example, the wheelchair 100 includes a motorized actuator 224B and a pair of gas spring actuators 224A and 224C (FIG. 7) that assist the motorized actuator 224B in transitioning the wheelchair 100 from the sitting mode 102 to the standing mode 104. The motorized actuator 224B may be controlled using the control panel 112 (FIG. 1), as mentioned above. Each gas spring actuator 224A and 224C generally applies a bias force between the support section 130 and the side frame members 160 when in the compact state corresponding to the sitting mode 102. The bias force relieves at least a portion of the load that must be overcome by the motorized actuator 224B as it transitions from its compact state to the extended state to move the chassis 106 from the sitting mode 102 to the standing mode 104.

The user may transition the chassis 106 back to the sitting mode 102 using the control panel 112 (FIG. 1) to drive the motorized actuator 224B from its extended state to the compact state. This pulls the bar 220 toward the support section 130 and transitions the chassis 106 back to the sitting mode 102. Additionally, this causes the rear wheels 150 to extend away from the front wheels 152 along the horizontal axis 144.

Although the embodiments of the present disclosure have been described with reference to preferred embodiments, workers skilled in the art will recognize that changes may be made in form and detail without departing from the spirit and scope of the present disclosure.

1. A standing wheelchair comprising:
a chassis having a sitting mode, in which a support section of the chassis forms a seat configured to support a user in a sitting position, and a standing mode, in which the support section is configured to support a user in a standing position;
a pair of rear drive wheels connected to the chassis on a rear side of the support section; and
a pair of front support wheels connected to the chassis on a front side of the support section, which is opposite the rear side,
wherein the rear wheels move closer to the front wheels when the chassis transitions from the sitting mode to the standing mode.

2. The standing wheelchair according to claim 1, wherein the front support wheels and the rear drive wheels support the chassis on a floor surface when in the sitting and standing modes.

3. The standing wheelchair according to claim 2, wherein a center of gravity of the standing wheelchair when the chassis, in the sitting mode, supports a user in the sitting position has a first horizontal position that is between an axis of rotation of the rear drive wheels and an axis of rotation of the front support wheels.

4. The standing wheelchair according to claim 3, wherein the center of gravity of the standing wheelchair when the chassis, in the standing mode, supports a user in the standing position has a second horizontal position that is closer to the axis of rotation of the rear drive wheels and the axis of rotation of the front support wheels than when the chassis is in the sitting mode.

5. The standing wheelchair according to claim 4, wherein:
the support section of the chassis includes a middle frame section and an upper frame section;
when the chassis is in the sitting mode, the middle frame section forms a seat platform of the seat and is oriented in a horizontal direction, and the upper frame section forms a backrest of the seat and is oriented in a vertical direction; and
when the chassis is in the standing mode, the middle frame section and the upper frame section are oriented in the vertical direction and are configured to support a user's torso in a standing orientation.

6. The standing wheelchair according to claim 5, wherein:
the front support wheels are pivotably connected to a lower frame section of the chassis that includes a footrest; and
the footrest is configured to support a user's feet when the chassis is in the sitting and standing modes.

7. The standing wheelchair according to claim 6, wherein the middle frame section and the upper frame section are pivotably connected to each other through a pair of first pivotable connections, and the middle frame section is pivotably connected to the lower frame section through a pair of second pivotable connections.

8. The standing wheelchair according to claim 7, wherein a location of the second pivotable connections is adjustable relative to the footrest.

9. The standing wheelchair according to claim 7, wherein a location of the first pivotable connections is adjustable relative to the middle frame section.

10. The standing wheelchair according to claim 7, wherein:
the chassis includes a pair of side frame members, each side frame member having a first end pivotably connected to the middle frame section and a second end connected to one of the rear drive wheels;
the side frame members pivot relative to the middle frame section as the chassis moves between the sitting and standing modes; and
the second ends of the side frame members move closer to the front support wheels with the rear drive wheels as the chassis moves from the sitting mode to the standing mode.

11. The standing wheelchair according to claim 10, including a pair of manual propulsion wheels, each manual propulsion wheel connected to the first end of one of the side frame members and configured to drive rotation of a corresponding one of the rear drive wheels through a drive mechanism.

12. The standing wheelchair according to claim 11, wherein the drive mechanism includes:
a pair of first gears each connected to one of the manual propulsion wheels;
a pair of second gears each connected to one of the rear drive wheels; and
a pair of drive loops each connecting one of the first gears to a corresponding one of the second gears,
wherein rotation of each manual propulsion wheel drives rotation of the corresponding first gear, which drives movement of the drive loop, rotation of the corresponding second gear, and rotation of the rear drive wheel.

13. The standing wheelchair according to claim 12, wherein each drive loop is selected from the group consisting of a chain and a belt.

14. The standing wheelchair according to claim 12, wherein rotation of each manual propulsion wheel drives rotation of the corresponding rear drive wheel when the chassis is in both the sitting mode and the standing mode.

15. The standing wheelchair according to claim 14, wherein the first gears are each configured to rotate about an axis about which the first end of the corresponding side frame member pivots relative to the middle frame section.

16. The standing wheelchair according to claim 14, wherein each of the first gears is configured to rotate about a gear axis, and the first end of the corresponding side frame member is configured to pivot relative to the middle frame section about an axis that is different from the first gear axis.

17. The standing wheelchair according to claim 15, including an axle extending through hubs of the rear drive wheels and through the second gears.

18. The standing wheelchair according to claim 10, including one or more actuators each configured to assist in driving the chassis from the sitting mode to the standing mode, each actuator having a first end that is connected to the side frame members and a second end that is connected to the support section.

19. The standing wheelchair according to claim 18, wherein the one or more actuators include a gas spring actuator.

20. The standing wheelchair according to claim 18, wherein the one or more actuators include a motorized actuator.
